(19) United States
(12) Patent Application Publication
(10) Pub. No.: US 2025/0328336 A1
(43) Pub. Date: Oct. 23, 2025

(54) VEHICLE

(71) Applicant: SUBARU CORPORATION, Tokyo (JP)

(72) Inventors: Taiga IIJIMA, Tokyo (JP); Masaru OE, Tokyo (JP); Hajime UTSUNOMIYA, Tokyo (JP)

(73) Assignee: SUBARU CORPORATION, Tokyo (JP)

(21) Appl. No.: 19/092,180

(22) Filed: Mar. 27, 2025

(30) Foreign Application Priority Data
Apr. 18, 2024 (JP) 2024-067843

(51) Int. Cl. G06F 8/65; B60R 16/023

(52) U.S. Cl. CPC G06F 8/65; B60R 16/0231

(57) ABSTRACT

A vehicle includes: an object unit including an object unit processor and an object unit memory coupled thereto; a communication unit including a communication unit processor and a communication unit memory coupled thereto; and a central unit including a central unit processor and a central unit memory coupled thereto. The object unit memory includes a first storage to store an application. The central unit memory includes a second storage to store part of the application. The communication unit processor performs a process including transferring update data to the object unit. The object unit processor performs a process including: storing the partial application in the second storage; disabling the partial application stored in the first storage; and performing an update process. The central unit processor causes part of a function of the object unit to operate by the application stored in the second storage at least during the update process.

### CROSS-REFERENCE TO RELATED APPLICATIONS

The present application claims priority from Japanese Patent Application No. 2024-067843 filed on Apr. 18, 2024, the entire contents of which are hereby incorporated by reference.

### BACKGROUND

The disclosure relates to a vehicle.

In recent years, a technique for updating programs (hereinafter also referred to as “reprogramming”) for various electronic devices provided in a vehicle has been proposed.

For example, Japanese Unexamined Patent Application Publication No. 2019-064424 discloses a vehicle configured to execute reprogramming using data for update received by wireless communication.

### SUMMARY

An aspect of the disclosure provides a vehicle including an object unit, a communication unit, and a central unit. The object unit is provided in the vehicle. The object unit includes at least one object unit processor, and at least one object unit memory coupled to the object unit processor. The communication unit is provided in the vehicle. The communication unit includes at least one communication unit processor, and at least one communication unit memory coupled to the communication unit processor. The central unit is provided in the vehicle. The central unit includes at least one central unit processor, and at least one central unit memory coupled to the central unit processor. The object unit memory includes a first storage area configured to store an application to operate the object unit. The central unit memory includes a second storage area configured to temporarily store at least part of the application stored in the first storage area. The communication unit processor is configured to perform a process including transferring, to the object unit through the central unit, data for update obtained from an outside of the vehicle by wireless communication. The object unit processor is configured to perform a process including: storing, in the second storage area, the at least part of the application stored in the first storage area; disabling the at least part of the application stored in the first storage area; and performing an update process of writing the application after update to the first storage area based on the data for update transferred from the communication unit. The central unit processor is configured to cause at least part of a function of the object unit to operate by the application stored in the second storage area at least in a period from start of execution of the update process until the update process is completed.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 is a functional block diagram for describing a vehicle according to an embodiment of the disclosure;

FIG. 2 is a first conceptual diagram according to the embodiment of the disclosure;

FIG. 3 is a second conceptual diagram according to the embodiment of the disclosure;

FIG. 4 is a table for explaining an example of evacuation target specification information according to the embodiment of the disclosure;

FIGS. 5A and 5B illustrate figures for disclosure an example of a function performed by an application according to the embodiment of the disclosure;

FIG. 6 is a third conceptual diagram according to the embodiment of the disclosure;

FIG. 7 is a fourth conceptual diagram according to the embodiment of the disclosure;

FIG. 8 is a first sequence diagram for disclosure the flow of a process according to the embodiment of the disclosure; and

FIG. 9 is a second sequence diagram for disclosure the flow of a process according to the embodiment of the disclosure.

### DETAILED DESCRIPTION

In related art, electronic devices to be reprogrammed are not usable during execution of reprogramming, thus there has been a problem in that in a situation where electronic devices are to be used, for example, while a vehicle is running, it is not possible to execute reprogramming of various electronic devices related to the running of the vehicle.

It is desirable to enable reprogramming of electronic devices in a situation where the electronic devices are to be used.

An embodiment of the disclosure will be described in detail below with reference to the accompanying drawings. Specific dimensions, materials, numerical values, and the like presented in the embodiment are merely examples for facilitating understanding of the disclosure, and do not limit the disclosure unless otherwise stated. Note that elements having substantially the same function and configuration are labeled with the same symbol to omit a redundant description, and illustration of the elements not directly related to the disclosure is omitted.

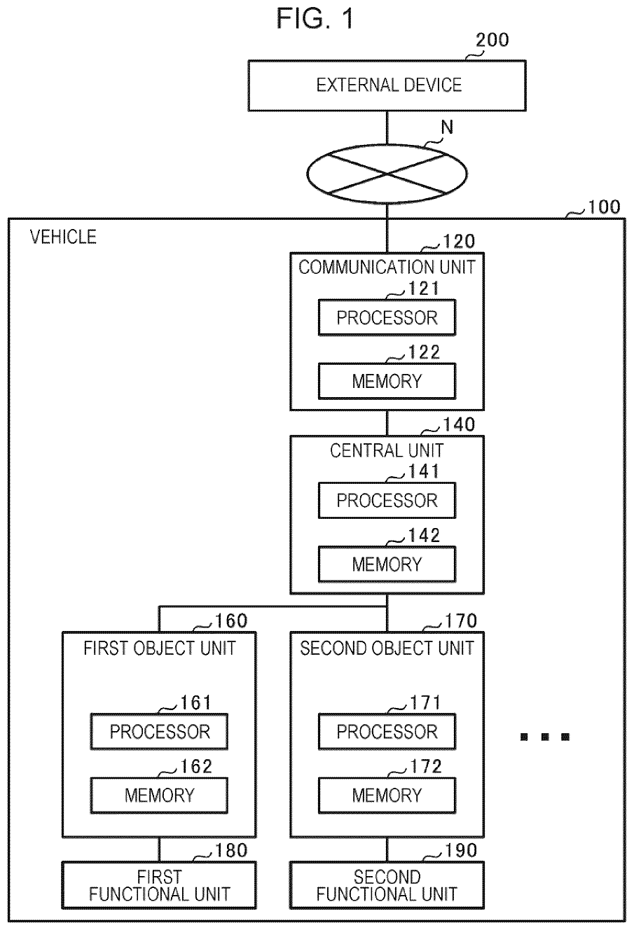

FIG. 1 is a functional block diagram for explaining a vehicle 100 according to this embodiment. As illustrated in FIG. 1, the vehicle 100 includes a communication unit 120, a central unit 140, a first object unit 160, a second object unit 170, a first functional unit 180, and a second functional unit 190. The vehicle 100 is a hybrid vehicle including e.g., an engine and a motor as running drive sources. However, the disclosure is applicable to various types of vehicle, such as a gasoline vehicle, an electric vehicle (EV), a plug-in hybrid vehicle (PHEV), and a non-plug-in hybrid vehicle (hybrid vehicle).

As illustrated in FIG. 1, the communication unit 120 includes one or multiple processors 121, and one or multiple memories 122 coupled to the processors 121. Each processor 121 includes e. g., a central processing unit (CPU). Each memory 122 includes a read only memory (ROM) which stores a program and the like, and a random access memory (RAM) as a work area. The processor 121 of the communication unit 120 coordinates with the program included in the memory 122 to perform wireless communication with an external device 200 via a communication network N.

The external device 200 is in charge of the function of distributing information for update used to update a program (hereinafter may also be referred to as “reprogramming”) for controlling various electronic devices installed in the vehicle 100. The information for update includes e.g., information to specify an object unit to be reprogrammed, and information on a program for update used in reprogramming. In this embodiment, a case has been presented where two types: the first object unit 160 and the second object unit 170 are provided as the object units to be reprogrammed; however, this is not always the case. For example, the number of object units may be one or may be three or more. These object units may be e.g., an engine controller that controls the engine, a motor controller that controls the motor, a battery controller that controls a battery, a wiper controller that controls a wiper, a light controller that controls light, a speedometer controller that controls display of a speedometer, a car navigation system controller that controls a car navigation system, and an automatic driving controller that controls automatic driving of the vehicle 100.

The communication network N is a wireless communication network for communicably coupling the vehicle 100 to the external device 200. The communication network N is comprised of various networks such as a satellite communication network, a mobile phone network, the Internet, a local area network (LAN), a wide area network (WAN), and other dedicated line networks. In order to communicably couple the vehicle 100 to the external device 200, at least part of the communication network N includes a wireless network. However, the communication network N may include a wired network in part. Alternatively, the vehicle 100 and the external device 200 may be communicably coupled to each other directly using short-range wireless communication such as Bluetooth without using the communication network N.

As illustrated in FIG. 1, the central unit 140 includes one or multiple processors 141, and one or multiple memories 142 coupled to the processors 141. Each processor 141 includes e.g., a CPU. Each memory 142 includes a ROM which stores a program and the like, and a RAM as a work area. The processor 141 of the central unit 140 serves as a so-called gateway by coordinating with the program included in the memory 142 to relay communication between various electronic devices installed in the vehicle 100. For example, the processor 141 of the central unit 140 has a function of relaying communication between the communication unit 120 and various object units. In addition, the processor 141 of the central unit 140 has a function of relaying communication between the various object units.

As illustrated in FIG. 1, the first object unit 160 includes one or multiple processors 161, and one or multiple memories 162 coupled to the processors 161. The second object unit 170 includes one or multiple processors 171, and one or multiple memories 172 coupled to the processors 171. The processors 161 and 171 include e.g. a CPU. The memories 162 and 172 include a ROM which stores a program and the like, and a RAM as a work area.

Each processor 161 of the first object unit 160 has a function of controlling various electronic devices installed in the vehicle 100 by coordinating with the program included in the memories 162. For example, the processor 161 of the first object unit 160 controls e.g., the first functional unit 180 coupled to the first object unit 160. Similarly, each processor 171 of the second object unit 170 has a function of controlling various electronic devices installed in the vehicle 100 by coordinating with the program included in the memories 172. For example, the processor 171 of the second object unit 170 controls e.g., the second functional unit 190 coupled to the second object unit 170.

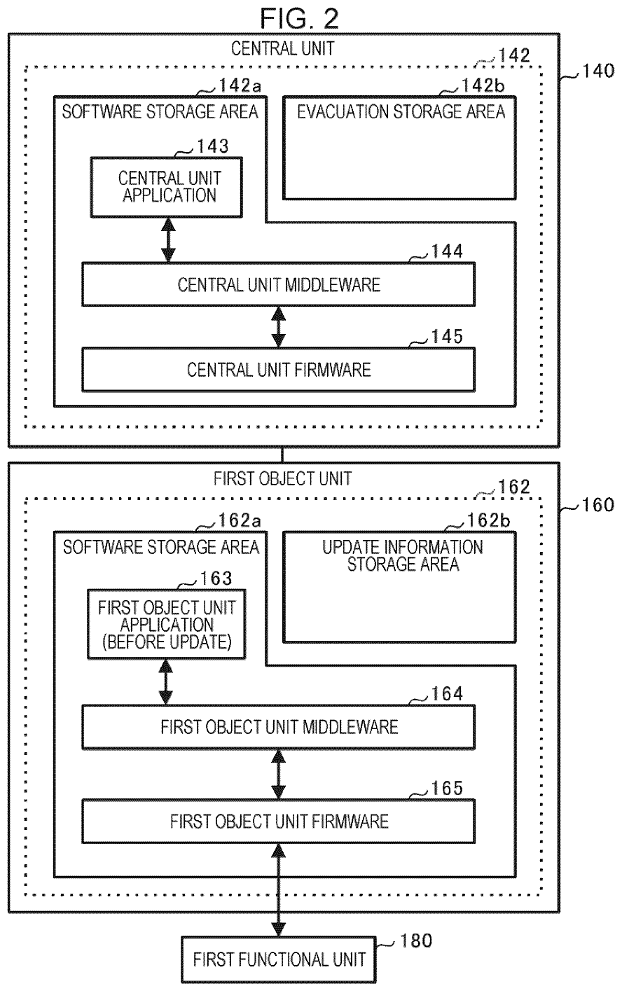

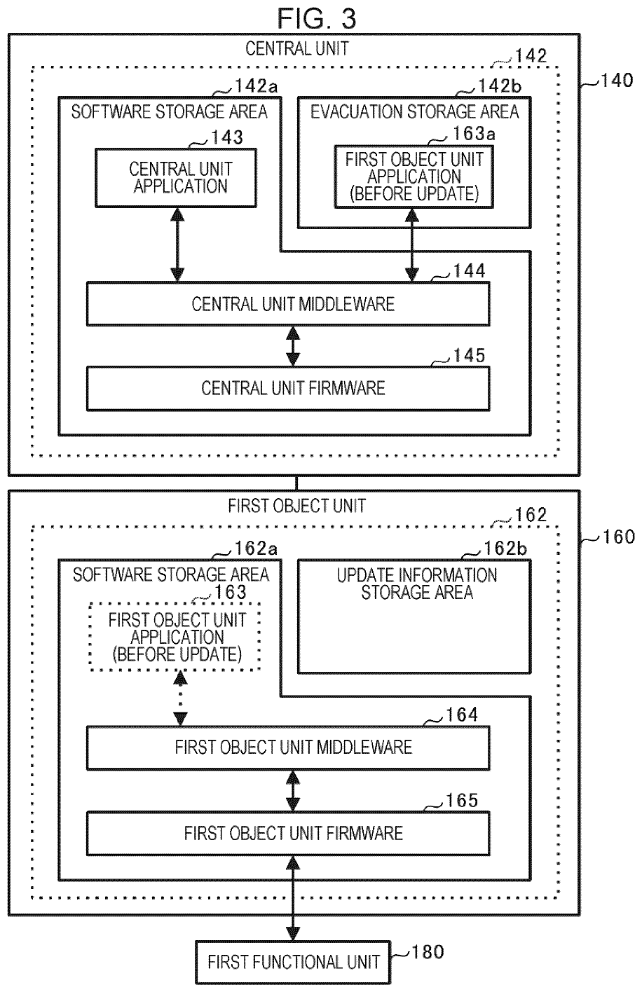

A case will be described where reprogramming for the first object unit 160 is executed. FIG. 2 is a first conceptual diagram according to the embodiment of the disclosure. FIG. 3 is a second conceptual diagram according to the embodiment of the disclosure. As illustrated in FIG. 2, the memory 142 of the central unit 140 is provided with a software storage area 142a and an evacuation storage area 142b. The software storage area 142a stores data for various pieces of software, used for the operation of the central unit 140 itself. For example, as illustrated in FIG. 2, the software storage area 142a stores a central unit application 143, a central unit middleware 144, and a central unit firmware 145. FIG. 2 illustrates a case where the software storage area 142a stores one central unit application 143; however, the software storage area 142a actually stores multiple central unit applications 143.

As illustrated in FIG. 2, the memory 162 of the first object unit 160 is provided with a software storage area 162a and an update information storage area 162b. The software storage area 162a stores data for various pieces of software, used for the operation of the first object unit 160 itself. For example, as illustrated in FIG. 2, the software storage area 162a stores a first object unit application 163, a first object unit middleware 164, and a first object unit firmware 165. FIG. 2 illustrates a case where the software storage area 162a stores one first object unit application 163; however, the software storage area 162a actually stores multiple first object unit applications 163.

An application is software specialized for implementing various functions. Firmware is software for directly controlling various pieces of hardware on an electronic device. Middleware is software that works as intermediate software between an application and firmware. In this embodiment, an application is a target of reprogramming, and middleware and firmware are excluded from the target of reprogramming.

When hardware control, such as drive of the wiper, and lighting of the light, is performed, the application performs a calculation process to derive various types of information used for controlling the hardware. The middleware requests the firmware to perform control of the hardware based on the various types of information derived by the application. The firmware accesses a hardware section and controls input/output thereto/therefrom, and causes the hardware to actually operate. Thus, the access to the hardware section and control of input/output thereto/therefrom are performed not by the application or middleware, but by the firmware.

Before execution of reprogramming, as illustrated in FIG. 2, the software storage area 162a stores the first object unit application 163 before update. As illustrated in FIG. 3, a first object unit application 163a is evacuated to the evacuation storage area 142b. The first object unit application 163a is at least part or all of the first object unit application 163 before update. In short, evacuation of an application means that at least part or all of the first object unit application 163 before update is copied or transferred to the evacuation storage area 142b.

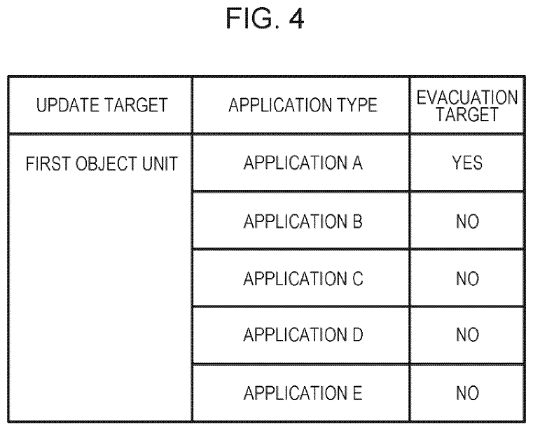

FIG. 4 is a table for explaining an example of evacuation target specification information according to the embodiment of the disclosure. The evacuation target specification information is stored in the memory 142 of the central unit 140, and includes respective pieces of evacuation target specification information for all the object units installed in the vehicle 100. However, when reprogramming is executed, the evacuation target specification information according to the object unit to be reprogrammed may be downloaded from the external device 200.

FIG. 4 illustrates the evacuation target specification information corresponding to the first object unit 160. As illustrated in FIG. 4, the evacuation target specification information includes information indicating whether each of all application types provided in the object unit to be reprogrammed is to be saved. FIG. 4 illustrates a case where the first object unit application 163 includes five applications as the application types, that is, application A to application E, and the application A is set as an evacuation target. However, the number of applications set as evacuation targets is not limited to this. For example, two or more applications may be set as evacuation targets. Alternatively, all applications provided in the object unit to be reprogrammed may be set as evacuation targets.

As illustrated in FIG. 3, when the first object unit application 163a is evacuated in the evacuation storage area 142b, the first object unit application 163 before update stored in the software storage area 162a is disabled. At this point, the first object unit middleware 164 and the first object unit firmware 165 remain enabled without being disabled. Note that the first object unit application 163 before update may be disabled by clearing various data related to the first object unit application 163 before update, for example, overwriting the various data with a predetermined value such as “0”. Alternatively, the first object unit application 163 before update may be disabled by setting the first object unit application 163 before update in an unusable state without clearing the various data related to the first object unit application 163 before update.

Thus, the first object unit application 163a evacuated in the evacuation storage area 142b is enabled. When the first object unit application 163a is enabled, the central unit 140 can cause the first object unit application 163a to be executed. In this case, the first functional unit 180 is operated by cooperation between the first object unit application 163a caused to be executed by the central unit 140, and the first object unit middleware 164 and the first object unit firmware 165 which are caused to be executed by the first object unit 160. However, the first functional unit 180 may be operated by giving predetermined instructions to the first object unit middleware 164 and the first object unit firmware 165 which are caused to be executed by the first object unit 160 based on the cooperation between the first object unit application 163a, the central unit middleware 144, and the central unit firmware 145 which are caused to be executed by the central unit 140.

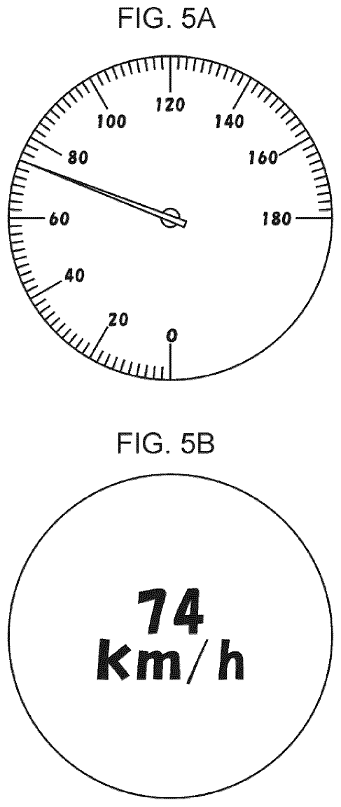

FIGS. 5A and 5B illustrate figures for explaining an example of a function performed by an application according to the embodiment of the disclosure. For example, the first object unit 160 controls switching between display modes of the speedometer. In this case, the speedometer is displayed in an analog mode as illustrated in FIG. 5A by e.g., the application A. In addition, the speedometer is displayed in a digital mode as illustrated in FIG. 5B by the application B. The speedometer is displayed in other display modes by the application C to the application E. In this case, the application A in charge of the display function of the speedometer in the analog mode illustrated in FIG. 5A is evacuated in the evacuation storage area 142b. In other words, as a substitute for the first object unit 160, the central unit 140 executes at least part of the function of controlling the applications in the first object unit 160.

For example, various calculation processes are performed by the first object unit application 163a of the central unit 140, and various types of information derived by the calculation processes are output to the first object unit middleware 164. The first object unit middleware 164 requests the first object unit firmware 165 to perform display control of the speedometer. The first object unit firmware 165 then accesses a hardware section and controls input/output thereto/therefrom for performing display control of the speedometer, and actually causes the hardware to operate. In this manner, the first object unit middleware 164 and the first object unit firmware 165 remain enabled without being disabled, thus as a substitute for the first object unit 160, the central unit 140 can execute at least part of the function of controlling the applications in the first object unit 160.

As described above, the time taken for evacuation of an application can be reduced by evacuating at least part of the application. Also, the storage capacity of the evacuation storage area 142b for evacuation of an application can be reduced, thus cost reduction can be achieved.

As described above, the central unit 140 has a function of relaying communication between the object units. In this embodiment, for example, when various types of communication are performed from the second object unit 170 to the first object unit 160, in normal times, various types of information from the second object unit 170 are transmitted to the first object unit 160 through the central unit 140. The various types of information generated in the first object unit 160 are transmitted to the second object unit 170 through the central unit 140, and a response is made.

As described above, various types of information are assumed to be transmitted from the second object unit 170 to the first object unit 160 while the central unit 140 as a substitute is executing at least part of the function of controlling the applications in the first object unit 160. In this case, the central unit 140 does not relay the various types of information to the first object unit 160, but as a substitute for the first object unit 160, causes the first object unit application 163a to be executed to generate various types of information, and transmits the generated various types of information to the second object unit 170. In this manner, as a substitute for the first object unit 160, the central unit 140 responds. Each object unit is provided with a function that detects an error when no response is made by another object unit to be communicated. As described above, response is made by the central unit 140 as a substitute for an object unit to be reprogrammed, thus, for the object unit to be reprogrammed, the possibility of detecting an error from another object unit can be reduced.

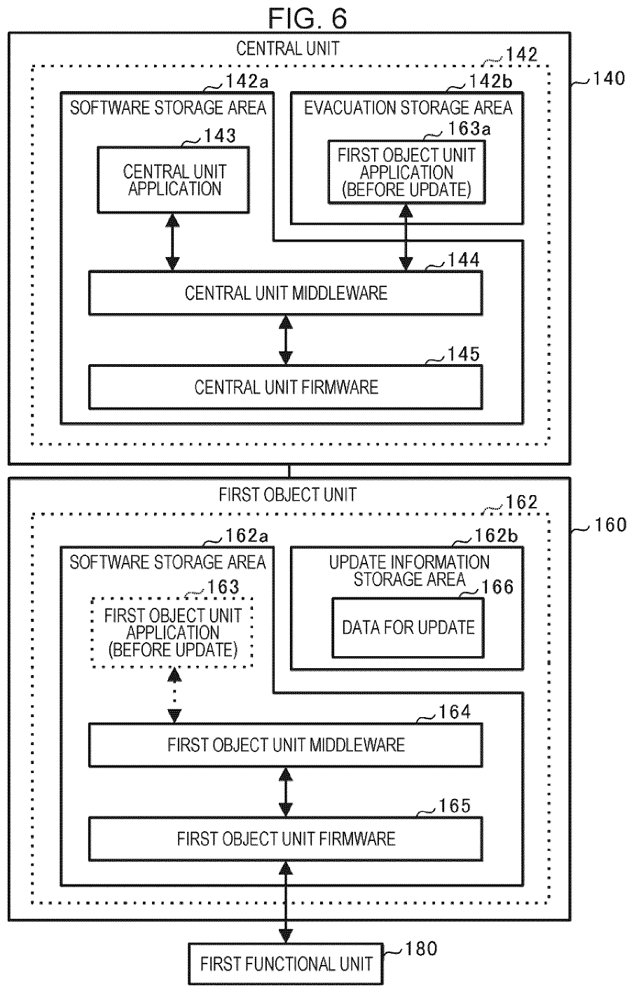

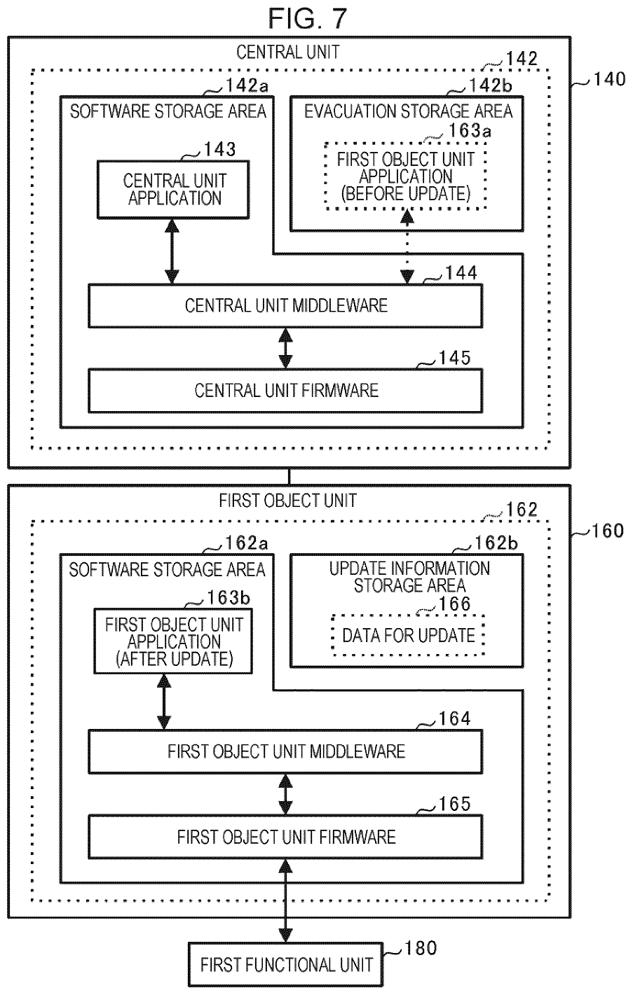

FIG. 6 is a third conceptual diagram according to the embodiment of the disclosure. FIG. 7 is a fourth conceptual diagram according to the embodiment of the disclosure. As illustrated in FIG. 6, when evacuation of the first object unit application 163a is completed, data 166 for update obtained from the external device 200 through the communication unit 120 is stored in the update information storage area 162b. For example, the communication unit 120 obtains the data 166 for update from the external device 200 through the communication network N. The communication unit 120 then transfers the obtained data 166 for update to the first object unit 160 through the central unit 140. The first object unit 160 stores the transferred data 166 for update in the update information storage area 162b.

As illustrated in FIG. 7, the first object unit 160 executes reprogramming based on the data 166 for update stored in the update information storage area 162b.

Consequently, a first object unit application 163b after update is stored in the software storage area 162a. As illustrated in FIG. 7, when the first object unit application 163b after update is stored in the software storage area 162a, the first object unit application 163a in the evacuation storage area 142b is disabled. The first object unit application 163b after update is then enabled. In addition, the data 166 for update is disabled. In this manner, even an object unit in charge of functions related to the running and the like of the vehicle 100 can execute reprogramming while the vehicle 100 is running.

In this embodiment, the case has been described in detail where reprogramming of the first object unit 160 is executed; however, even when reprogramming of the second object unit 170 is executed, at least part of the applications of the second object unit 170 is evacuated to the evacuation storage area 142b in the same manner. In other words, the evacuation storage area 142b is used in common by object units. Providing the central unit 140 having a gateway function with the evacuation storage area 142b for evacuating an application can reduce the cost, as compared to when each object unit is provided with a storage area for evacuating an application. The various processes for implementing the above-mentioned functions will be described below.

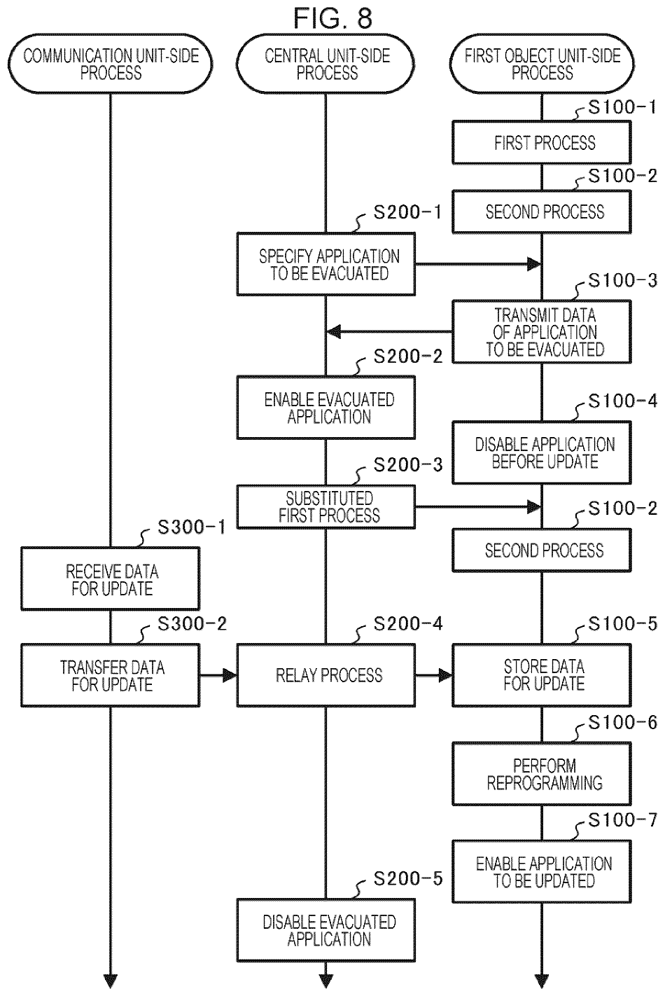

FIG. 8 is a first sequence diagram for explaining the flow of a process according to the embodiment of the disclosure. The various processes including the process described below can be performed by the processors 121 of the communication unit 120, the processors 141 of the central unit 140, and the processors 161 of the first object unit 160.

When the first object unit application 163 before update is enabled, as illustrated in FIG. 8, for the first object unit 160, a first process is performed by the first object unit application 163 (S100-1). In the first process, a calculation process is performed to derive various types of information used for controlling the hardware, and the various types of information derived by the calculation process are output to the first object unit middleware 164.

The first object unit middleware 164 and the first object unit firmware 165 of the first object unit 160 perform a second process based on the various types of information derived by the first process (S100-2). In the second process, the first object unit middleware 164 requests the first object unit firmware 165 to perform control of the hardware. The first object unit firmware 165 accesses the first functional unit 180 and controls input/output thereto/therefrom, and causes the first functional unit 180 to actually operate.

The central unit 140 transmits to the first object unit 160 information that can identify the application type to be evacuated, based on the evacuation target specification information (FIG. 4) corresponding to the first object unit 160 (S200-1). The first object unit 160 transmits various types of information related to the application specified based on the received information to the central unit 140 (S100-3). In other words, the first object unit 160 transmits at least part of applications included in the first object unit application 163 to the central unit 140. When evacuation of the application is completed, the central unit 140 enables the first object unit application 163a (S200-2).

When the first object unit application 163a is enabled by the central unit 140, the first object unit 160 disables the first object unit application 163 before update (S100-4). At this point, in the first object unit 160, the first object unit middleware 164 and the first object unit firmware 165 which are stored in the software storage area 162a remain in an enabled state without being disabled.

In the manner as described above, a transition from the first object unit application 163 before update to the evacuated first object unit application 163a can be made without a time gap.

The central unit 140 then performs a substituted first process (S200-3). In the substituted first process, as a substitute for the first object unit 160, the central unit 140 performs a process similar to the first process (S100-1). The central unit 140 then outputs various types of information derived by the substituted first process to the first object unit middleware 164.

The first object unit middleware 164 and the first object unit firmware 165 of the first object unit 160 perform the second process based on the various types of information derived by the substituted first process (S100-2). In this manner, the first functional unit 180 can be caused to operate even if the first object unit application 163 before update is in a disabled state.

The communication unit 120 receives the data 166 for update from the external device 200 through the communication network N (S300-1). The communication unit 120 transfers the received data 166 for update to the first object unit 160 through the central unit 140 (S300-2). The central unit 140 performs a relay process of transmitting the data 166 for update received from the communication unit 120 to the first object unit 160 (S200-4). The first object unit 160 then stores, in the update information storage area 162b, the data 166 for update received from the communication unit 120 through the central unit 140 (S100-5).

The first object unit 160 executes the reprogramming based on the data 166 for update stored in the update information storage area 162b (S100-6). Thus, the first object unit application 163b after update is stored in the software storage area 162a. When the first object unit application 163b after update is stored in the software storage area 162a and the reprogramming is completed, the first object unit 160 enables the first object unit application 163b after update (S100-7).

Subsequently, the central unit 140 disables the first object unit application 163a in the evacuation storage area 142b (S200-5). In this manner, a transition from the first object unit application 163a in the evacuation storage area 142b to the first object unit application 163b after update can be made without a time gap.

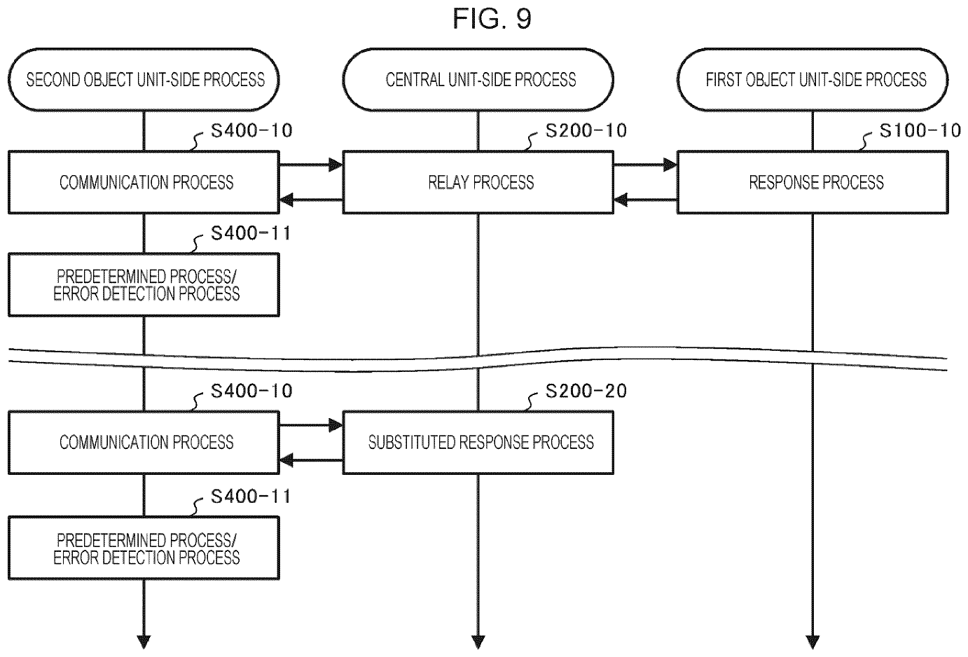

FIG. 9 is a second sequence diagram for explaining the flow of a process according to the embodiment of the disclosure. The various processes including the process described below can be performed by the processors 141 of the central unit 140, the processors 161 of the first object unit 160, and the processors 171 of the second object unit 170.

In normal times, in other words, while the function of controlling the applications in the first object unit 160 is not being executed by the central unit 140 as a substitute, as illustrated in the upper part of FIG. 9, the second object unit 170 is assumed to perform a communication process of transmitting predetermined information to the first object unit 160 through the central unit 140 (S400-10). In this case, the central unit 140 performs a relay process of transmitting the predetermined information received from the second object unit 170 to the first object unit 160 (S200-10). The first object unit 160 generates various types of information for the received predetermined information, and performs a response process of transmitting the generated various types of information to the second object unit 170 through the central unit 140 (S100-10). The second object unit 170 performs a predetermined process based on the various types of information received from the first object unit 160 through the central unit 140 (S400-11). The predetermined process includes an error detection process that can detect an error when various types of information are not received normally from the first object unit 160.

While the function of controlling the applications in the first object unit 160 is being executed by the central unit 140 as a substitute, as illustrated in the lower part of FIG. 9, the second object unit 170 is assumed to perform a communication process of transmitting predetermined information to the first object unit 160 through the central unit 140 (S400-10). In this case, the central unit 140 does not perform a relay process, but as a substitute for the first object unit 160, generates various types of information, and performs a substituted response process of transmitting the generated various types of information to the second object unit 170 (S200-20). When receiving the various types of information generated by the central unit 140, the second object unit 170 assumes that the various types of information are received from the first object unit 160, and performs a predetermined process (S400-11). In this case, the various types of information are assumed to be normally received from the first object unit 160, and thus the second object unit 170 will not detect an error. Thus, when reprogramming is executed during running of the vehicle 100, the possibility of detecting an error unintentionally can be reduced.

As described above, the vehicle 100 according to this embodiment includes an object unit (a first object unit 160) provided in the vehicle 100, the object unit (the first object unit 160) including one or multiple object unit processors (processors 161), and one or multiple object unit memories (memories 162) coupled to the object unit processors (the processors 161). In addition, the vehicle 100 includes a communication unit 120 provided in the vehicle 100, the communication unit 120 including one or multiple communication unit processors (processors 121), and one or multiple communication unit memories (memories 122) coupled to the communication unit processors (the processors 121). In addition, the vehicle 100 includes a central unit 140 provided in the vehicle 100, the central unit 140 including one or multiple central unit processors (processors 141), and one or multiple central unit memories (memories 142) coupled to the central unit processors (the processors 141). Each object unit memory (a memory 162) includes a first storage area (a software storage area 162a) to store an application (a first object unit application 163) for operating the object unit (the first object unit 160). Each central unit memory (a memory 142) includes a second storage area (an evacuation storage area 142b) that temporarily stores at least part of the application (the first object unit application 163) stored in the first storage area (the software storage area 162a). Each communication unit processor (a processor 121) performs a process including transferring, to the object unit (the first object unit 160) through the central unit 140, data 166 for update obtained from the outside of the vehicle 100 by wireless communication (steps S300-1 and S300-2 as an example in the embodiment). Each object unit processor (a processor 161) performs a process including storing, in the second storage area, the at least part of the application (the first object unit application 163) stored in the first storage area (the software storage area 162a) (step S100-3 as an example in the embodiment). The object unit processor (the processor 161) performs a process including disabling the at least part of the application (the first object unit application 163) stored in the first storage area (the software storage area 162a) (step S100-4 as an example in the embodiment). The object unit processor (the processor 161) performs a process including execution of an update process of writing the application after update (the first object unit application 163a) to the first storage area (the software storage area 162a) based on the data 166 for update transferred from the communication unit 120 (step S100-6 as an example in the embodiment). Each central unit processor (a processor 141) causes at least part of the functions of the object unit (the first object unit 160) to operate by the application (the first object unit application 163a) stored in the second storage area (the evacuation storage area 142b) at least in a period from start of execution of the update process until the update process is completed (step S200-3 as an example in the embodiment).

In the vehicle 100 of the embodiment like this, in a situation where electronic devices are to be used, such as while the vehicle 100 is running, even for an object unit in charge of functions related to the running and the like of the vehicle 100, it is possible to execute reprogramming of various electronic devices related to the running of the vehicle 100.

The central unit processor (the processor 141) may be able to cause a peripheral device (the first functional unit 180) coupled to the object unit (the first object unit 160) to operate through the object unit (the first object unit 160) by the application (the first object unit application 163a) stored in the second storage area (the evacuation storage area 142b) (step S200-3 as an example in the embodiment). When disabling the at least part of the application (the first object unit application 163) stored in the first storage area (the software storage area 162a), the object unit processor (the processor 161) may maintain predetermined software (the first object unit middleware 164 and the first object unit firmware 165) for operating the peripheral device coupled to the object unit (step S100-4 as an example in the embodiment).

In this manner, the first functional unit 180 can be operated even if the first object unit application 163 before update is in a disabled state. Thus in a situation where electronic devices are to be used, such as while the vehicle 100 is running, it is possible to execute reprogramming of various electronic devices related to the running of the vehicle 100.

The vehicle 100 may be provided with a detection unit (the second object unit 170) including one or multiple detection unit processors (processors 171), and one or multiple detection unit memories (memories 172) coupled to the detection unit processors (the processors 171). When the at least part of the function of the object unit (the first object unit 160) is in operation by the central unit processor (the processor 141), the detection unit processors (the processors 171) may assume that the function of the object unit (the first object unit 160) is operated normally (step S400-11 as an example in the embodiment).

In this manner, when reprogramming is executed during running of the vehicle 100, the possibility of detecting an error unintentionally can be reduced. In the above embodiment, the case has been illustrated where the object unit can make error detection, but a unit dedicated to error detection may be provided.

The embodiments and modifications of the disclosure have been described above with reference to the accompanying drawings; however, the disclosure is not limited to those embodiments and modifications. It is apparent that various modifications and alterations may occur to those skilled in the art in the category described in claims, and it is understood that these also naturally belong to the technical scope of the disclosure.

Note that a series of processes performed by the vehicle 100 according to the above embodiment may be implemented using one of software, hardware, or a combination of software and hardware. Each program included in software is pre-stored in e.g., non-transitory media provided internally or externally of devices. The program is read from the non-transitory media (e.g., a ROM) to a temporary storage medium (e.g., a RAM), and is executed by a processor such as a CPU.

According to the embodiment, a program for executing the process of each function of the vehicle 100 can be provided. Furthermore, it is also possible to provide a computer-readable non-transitory recording medium. The non-transitory recording medium may be a disk recording medium such as an optical disk, a magnetic disk, and a magneto-optical disk, or a semiconductor memory such as a flash memory, and a USB memory.

The vehicle 100 illustrated in FIG. 1 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the vehicle 100 including the communication unit 120, the central unit 140, the first object unit 160, the second object unit 170, the first functional unit 180, and the second functional unit 190. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 1.

1. A vehicle comprising:
an object unit provided in the vehicle, the object unit comprising at least one object unit processor, and at least one object unit memory coupled to the object unit processor;
a communication unit provided in the vehicle, the communication unit comprising at least one communication unit processor, and at least one communication unit memory coupled to the communication unit processor; and
a central unit provided in the vehicle, the central unit comprising at least one central unit processor and at least one central unit memory coupled to the central unit processor,
wherein the object unit memory comprises
a first storage area configured to store an application to operate the object unit, the central unit memory comprises
a second storage area configured to temporarily store at least part of the application stored in the first storage area,
the communication unit processor is configured to perform
a process comprising transferring, to the object unit through the central unit, data for update obtained from an outside of the vehicle by wireless communication,
the object unit processor is configured to perform a process comprising:
storing, in the second storage area, the at least part of the application stored in the first storage area;
disabling the at least part of the application stored in the first storage area; and
performing an update process of writing the application after update to the first storage area based on the data for update transferred from the communication unit, and
the central unit processor is configured to cause
at least part of a function of the object unit to operate by the application stored in the second storage area at least in a period from start of execution of the update process until the update process is completed.

2. The vehicle according to claim 1, wherein
the central unit processor is
configured to cause a peripheral device coupled to the object unit to operate through the object unit by the application stored in the second storage area, and
the object unit processor is
configured to, upon disabling the at least part of the application stored in the first storage area, maintain predetermined software for operating the peripheral device coupled to the object unit.

3. The vehicle according to claim 1, further comprising
a detection unit provided in the vehicle, the detection unit comprising at least one detection unit processor, and at least one detection unit memory coupled to the detection unit processor,
wherein the detection unit processor is configured to, when the at least part of the function of the object unit is in operation by the central unit processor, assume that the function of the object unit is in normal operation.

4. The vehicle according to claim 2, further comprising
a detection unit provided in the vehicle, the detection unit comprising at least one detection unit processor, and at least one detection unit memory coupled to the detection unit processor,
wherein the detection unit processor is configured to, when the at least part of the function of the object unit is in operation by the central unit processor, assume that the function of the object unit is in normal operation.
